(19) United States
(12) Patent Application Publication
(10) Pub. No.: US 2025/0194818 A1
(43) Pub. Date: Jun. 19, 2025

(54) ELASTIC MATTRESS

(71) Applicant: Luhao LENG, Xiamen (CN)

(72) Inventor: Luhao LENG, Xiamen (CN)

(21) Appl. No.: 18/973,411

(22) Filed: Dec. 9, 2024

(30) Foreign Application Priority Data
Dec. 14, 2023 (CN) 202311720556.3

(51) Int. Cl. A47C 27/07; A47C 27/045; A47C 27/06

(52) U.S. Cl. CPC A47C 27/07; A47C 27/0453; A47C 27/0456; A47C 27/064

(57) ABSTRACT

An elastic mattress, the elastic mattress includes one or more elastic modules, one or more bottom layers disposed on a lower side of the one or more elastic modules, and one or more lap joints. The one or more elastic modules comprises a plurality of pre-compressed springs, connecting members are disposed on middle parts of the plurality of pre-compressed springs, corresponding ones of the middle parts on adjacent pre-compressed springs of the plurality of pre-compressed springs are connected together, the connecting members are connected to the one or more lap joints, the one or more lap joints are connected to the adjacent pre-compressed springs, and bottom surfaces of the plurality of pre-compressed springs are connected to the one or more bottom layers.

### RELATED APPLICATIONS

This application claims priority to Chinese patent application number 202311720556.3, filed on Dec. 14, 2023. Chinese patent application number 202311720556.3 is incorporated herein by reference.

### FIELD OF THE DISCLOSURE

The present disclosure relates to the field of furniture, and in particular relates to an elastic mattress.

### BACKGROUND OF THE DISCLOSURE

Bed mattresses are essential furniture in beddings for human use in modern life. Elastic bed mattresses with a middle part having elastic components are becoming increasingly popular for relaxation during sleep with increasing pressure in human lives. A soft mattress, elastic components, and a base of the existing elastic bed mattresses having the elastic components are usually integrated to form a whole structure. Upper ends of springs are connected together, causing surrounding elastic components to be simultaneously stressed when a local stress is applied to the elastic mattress. Therefore, a range of the stress applied to the elastic components of the existing elastic mattresses cannot be adjusted following a body posture on the elastic mattress. Additionally, the stress applied to the elastic mattress cannot be adjusted according to a sleeping posture of a person to enable the elastic mattress to conform to a curve of a human body to be softer and more comfortable. In addition, after a long-time of use, the elasticity of the springs may change, and bacteria and mites breed on the elastic mattress. The soft cushion and the base of the elastic mattress are integrated with the elastic components, so it is difficult to judge a usage state and a wear level of the elastic mattress during usage, and it is impossible to clean and replace components of the elastic mattress, such as the soft mattress, the elastic components, and the base, according to the usage state and the wear level, so as to maintain comfort and softness of the elastic mattress.

### BRIEF SUMMARY OF THE DISCLOSURE

The technical problem to be solved by the present disclosure is to provide an elastic mattress. A stress applied to a plurality of pre-compressed springs can be adjusted according to a posture of a human body, allowing the elastic mattress to conform to a curve of the human body, thus enabling the elastic mattress to be more ergonomic, soft, and comfortable.

In order to solve the aforementioned technical problems, the present disclosure provides an elastic mattress, the elastic mattress comprises one or more elastic modules, one or more bottom layers disposed on a lower side of the one or more elastic modules, and one or more lap joints. The one or more elastic modules comprises a plurality of pre-compressed springs, connecting members are disposed on middle parts of the plurality of pre-compressed springs, corresponding ones of the middle parts on adjacent pre-compressed springs of the plurality of pre-compressed springs are connected together, the connecting members are connected to the one or more lap joints, the one or more lap joints are connected to the adjacent pre-compressed springs, and bottom surfaces of the plurality of pre-compressed springs are connected to the one or more bottom layers.

In some embodiments, the connecting members comprise connecting seats, the connecting seats comprise first connecting structures, the one or more lap joints comprise one or more second connecting structures, and the first connecting structures are connected to the one or more second connecting structures to realize a connection of the connecting members and the one or more lap joints.

In some embodiments, the connecting seats comprise insertion members as the first connecting structures, the one or more lap joints comprises one or more insertion sockets as the one or more second connecting structures, and a male-female connection of the insertion members and the one or more insertion sockets realizes the connection of the connecting members and the one or more lap joints.

In some embodiments, the connecting seats comprise protrusions as the insertion members, the one or more lap joints comprises grooves as the one or more insertion sockets, and the protrusions are positioned at and cooperate with the grooves.

In some embodiments, the protrusions are evenly disposed on four sides of the connecting seats.

In some embodiments, the grooves are disposed on four sides of the one or more lap joints.

In some embodiments, the one or more lap joints comprise one or more fixed seats and knobs connected to four sides of the one or more fixed seats, and the knobs comprises the grooves configured to be matched with the protrusions. After the protrusions are buckled to the grooves and the protrusions are locked by rotating the knobs, so as to realize the connection of the connecting members and the one or more lap joints.

In some embodiments, one or more pre-compressed springs of the plurality of pre-compressed springs at an outer periphery of the one or more elastic modules are connected by corresponding ones of the one or more lap joints or buckled to each other by corresponding ones of the connecting members.

In some embodiments, each of the connecting members comprises two or more connecting member assemblies buckled to a corresponding one of the middle parts of the plurality of pre-compressed springs.

In some embodiments, the two or more connecting member assemblies of each of the connecting members are buckled to each other.

In some embodiments, the elastic mattress further comprises one or more upper mattress layers, and the one or more upper mattress layers are disposed on an upper side of the one or more elastic modules or cover an upper side and a periphery of the one or more elastic modules.

In some embodiments, the one or more upper mattress layers are detachably connected to one or more outermost pre-compressed springs of the plurality of pre-compressed springs of the one or more elastic modules.

In some embodiments, a plurality of strips having pull buckles are disposed on a periphery of the one or more upper mattress layers, the plurality of strips having pull buckles are connected to corresponding ones of the connecting members or corresponding ones of the one or more lap joints, and the corresponding ones of the connecting members or the corresponding ones of the one or more lap joints are located on one or more peripheral pre-compressed springs of the plurality of pre-compressed springs of the one or more elastic modules.

In some embodiments, the one or more upper mattress layers are integrally formed or formed by combining a plurality of mattress layers of the one or more mattress layers with different softness and hardness.

In some embodiments, the one or more bottom layers are detachably spliced by a plurality of bottom layer units or integrally molded.

In some embodiments, the one or more bottom layers comprise a plurality of bottom layers, and the plurality of bottom layers are detachably spliced together to form a base for the one or more elastic modules.

In some embodiments, the plurality of bottom layer units or the plurality of bottom layers are connected together through third members.

In some embodiments, the third members are connecting knobs, a bottom of each of the connecting knobs comprises two T-shaped buckling pins symmetrical to each other, a periphery of each of the plurality of bottom layer units or a periphery of each of the plurality of bottom layers comprises sliding rails, each of the sliding rails is configured to be connected to a corresponding one of the two T-shaped buckling pins of a corresponding one of the connecting knobs, widths of the sliding rails narrow along a rotation direction of the connecting knobs, the two T-shaped buckling pins of each of the connecting knobs are respectively buckled to a wide part of a corresponding one of the sliding rails on a first bottom layer unit of the plurality of bottom layer units or a first bottom layer of the plurality of bottom layers and a wide part of a corresponding one of the sliding rails on a second bottom layer unit of the plurality of bottom layer units adjacent to the first bottom layer unit or a second bottom layer of the plurality of bottom layers adjacent to the first bottom layer, and each of the connecting knobs rotates to enable the two T-shaped buckling pins to be positioned to a narrow part of the corresponding one of the sliding rails on the first bottom layer unit or the first bottom layer and a narrow part of the corresponding one of the sliding rails on the second bottom layer unit or the second bottom layer, so as to achieve a connection between the first bottom layer unit and the second bottom layer unit or a connection between the first bottom layer and the second bottom layer.

In some embodiments, the plurality of pre-compressed springs are connected to the one or more bottom layers through fixing members.

In some embodiments, at least part of the one or more bottom layers is disposed with the fixing members.

In some embodiments, the fixing members are a plurality of positioning protrusions disposed on the plurality of bottom layer units, lower end surfaces of the plurality of pre-compressed springs comprise a plurality of cavities configured to be positioned at and cooperate with the plurality of positioning protrusions, and the plurality of pre-compressed springs are connected to the one or more bottom layers by a male-female connection between the plurality of positioning protrusions and the plurality of cavities.

In some embodiments, the one or more bottom layers are formed by a rigid substrate or a flexible substrate.

In some embodiments, the plurality of pre-compressed springs are configured to be compressed to a locked state.

In some embodiments, each of the plurality of pre-compressed springs comprises a top cover and a bottom cover, a spring is disposed between the top cover and the bottom cover, positioning structures are disposed between the top cover and the bottom cover, and the top cover is buckled to the bottom cover through the positioning structures to compress each of the plurality of pre-compressed springs to the locked state.

In some embodiments, the positioning structures are divided into a first positioning structure and a second positioning structure, the first positioning structure is disposed on a lower end surface of the top cover, the second positioning structure is disposed on an upper end surface of the bottom cover, the first positioning structure and the second positioning structure are detachably buckled to each other, when the first positioning structure and the second positioning structure are buckled to each other, each of the plurality of pre-compressed springs is compressed, and when the first positioning structure and the second positioning structure are detached from each other, each of the plurality of pre-compressed springs is released.

In some embodiments, a lower end surface of the bottom cover of each of the plurality of pre-compressed springs comprises a cavity, and the bottom cover defines a top surface of the cavity.

In some embodiments, the second positioning structure is discontinuous flanges disposed on the top surface of the cavity.

The present disclosure discloses a method for applying the elastic mattress, the method comprises applying the elastic mattress in a sofa, a bed mattress, or a soft stool.

Compared with the existing techniques, the present disclosure has the following advantages.

1. In the elastic mattress of the present disclosure, upper ends of the plurality of pre-compressed springs for forming the one or more elastic modules are independent, so that a stress applied to the plurality of pre-compressed springs of the elastic mattress can conform to a curve of a human body according to a posture of the human body to enable the elastic mattress to be softer and more comfortable.

2. In the elastic mattress of the present disclosure, the one or more upper mattress layers and the one or more elastic modules are detachably connected together, and the one or more upper mattress layers are disposed on an upper side of the one or more elastic modules. A usage state of the elastic mattress can be judged in a process of using the elastic mattress, so that the elastic mattress can be cleaned and replaced in time.

3. In the elastic mattress of the present disclosure, the plurality of pre-compressed springs can be compressed to the locked state. In transportation or relocation of the elastic mattress, the detached plurality of pre-compressed springs can be compressed to save transportation space and to facilitate the relocation.

### BRIEF DESCRIPTION OF THE DRAWINGS

FIG. 1 is a perspective view of an elastic mattress in Embodiment 1;

FIG. 2 is a perspective view of a pre-compressed spring in Embodiment 1;

FIG. 3 is a perspective view of a connecting member in Embodiment 1.

FIG. 4 is a perspective view of a lap joint in Embodiment 1;

FIG. 5 is a top view of a connection relation in Embodiment 1;

FIG. 6 is a perspective view of a graphical object of an elastic module in Embodiment 1;

FIG. 7 is a perspective view of a graphical object of a protrusion being buckled to the lap joint in Embodiment 1;

FIG. 8 is a perspective view of a graphical object of the protrusion being locked by the lap joint in Embodiment 1;

FIG. 9 is a perspective view of a graphical object of the connection relation in Embodiment 1;

FIG. 10 is a perspective view of a strip having a pull buckle connected to the elastic module in Embodiment 1;

FIG. 11 is a perspective view of the strip having the pull buckle and a three-way lap joint in Embodiment 1;

FIG. 12 shows a perspective view of a connection of outermost pre-compressed springs of the elastic mattress in Embodiment 1;

FIG. 13 is a perspective view of a graphical object of the strip having the pull buckle connected to the elastic module in Embodiment 1;

FIG. 14 is a perspective view of the elastic module connected to a base;

FIG. 15 is a top view of the base spliced by 8-seat bottom layer units;

FIG. 16 is a partial view of the base in which positioning protrusions are disposed on all of a bottom layer;

FIG. 17 is a partial view of the base in which the positioning protrusions are disposed on a periphery of the bottom layer;

FIG. 18 is a perspective view of a positioning protrusion;

FIG. 19 is a perspective view of a connecting knob;

FIG. 20 is a top view of the base spliced by 5-seat bottom layer units;

FIG. 21 is a top view of the base spliced by 5-seat and 1-seat bottom layer units;

FIG. 22 is a top view of a 5-seat bottom layer unit;

FIG. 23 is a top view of an 8-seat bottom layer unit;

FIG. 24 is a top view of a 3-seat bottom layer unit;

FIG. 25 is a top view of a 1-seat bottom layer unit;

FIG. 26 is a perspective view of a graphical object of the base;

FIG. 27 is a perspective view of a graphical object of the base in a disassembled state;

FIG. 28 is a perspective view of the pre-compressed spring in a released state; and

FIG. 29 is a perspective view of the pre-compressed spring in a compressed state.

### DETAILED DESCRIPTION OF THE EMBODIMENTS

The technical solutions in the embodiments of the present disclosure will be clearly and completely described below in combination with the accompanying drawings in the embodiments of the present disclosure. It is obvious that the described embodiments are preferred embodiments of the present disclosure and should not be understood as an exclusion of other embodiments. All other embodiments fall within the protection scope of the present disclosure provided that they are obtained based on the embodiments of the present disclosure by person of ordinary technical skill in the art without creative works.

### Embodiment 1

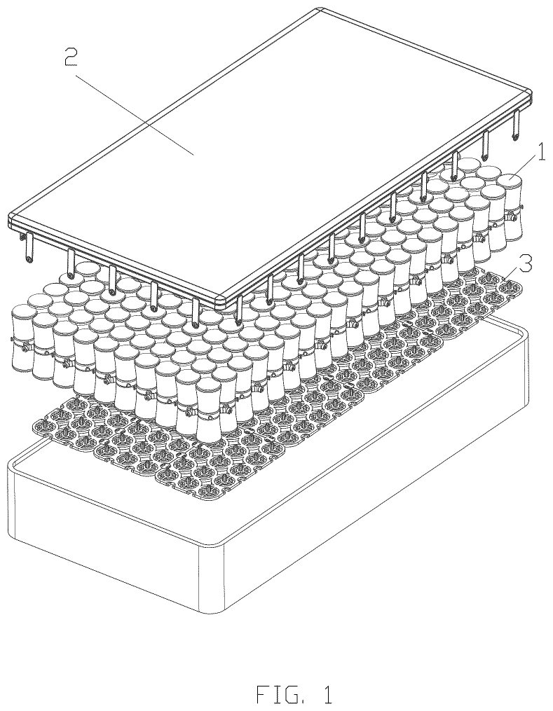

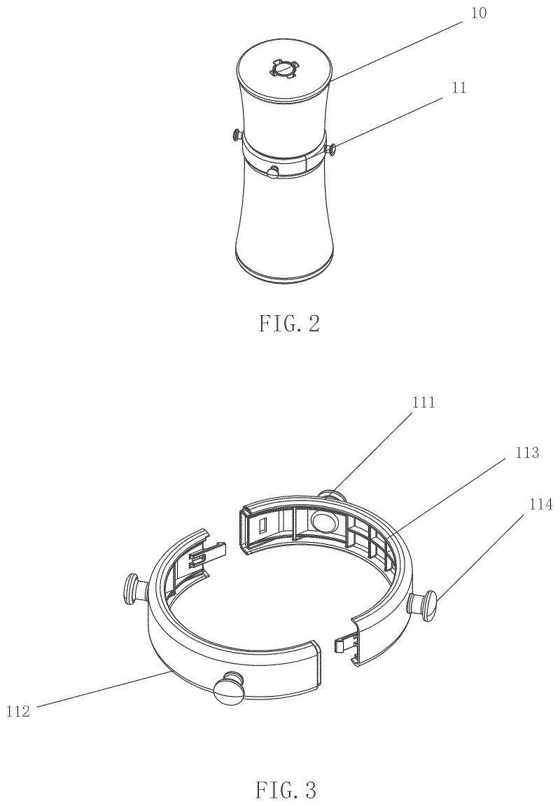

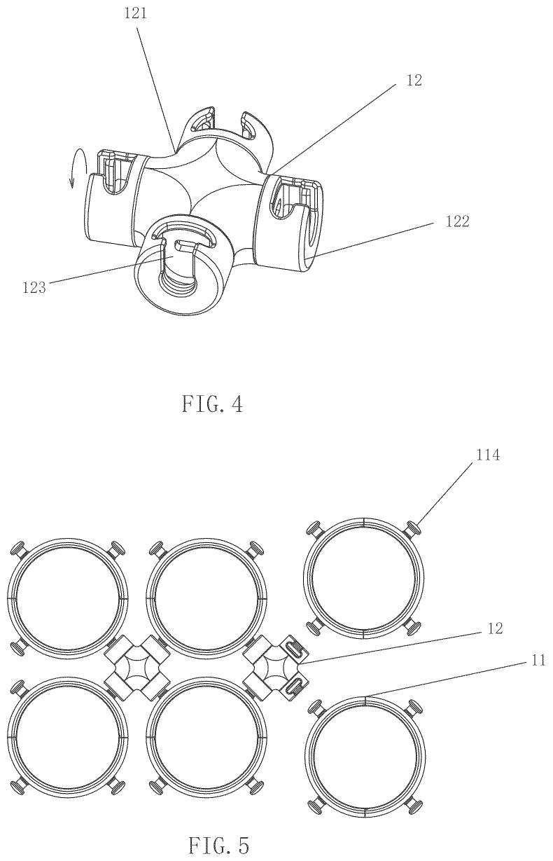

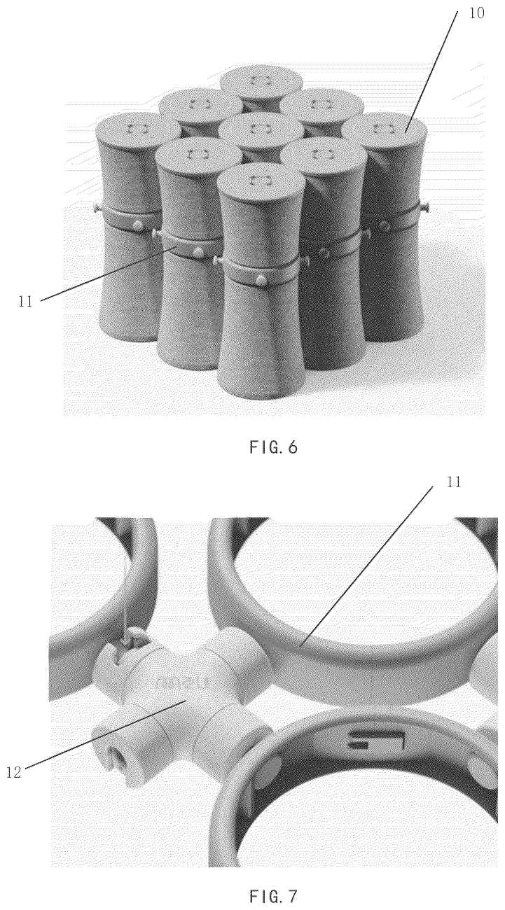

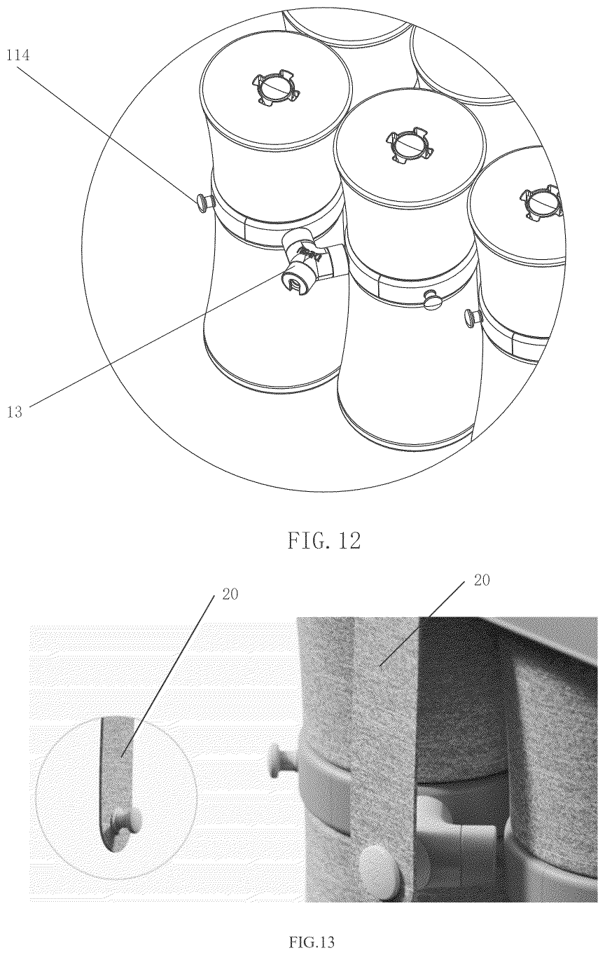

Referring to FIGS. 1-13, this embodiment provides an elastic mattress. The elastic mattress comprises a plurality of elastic modules 1, one or more upper mattress layers 2 disposed on an upper side of the plurality of elastic modules 1, and one or more bottom layers 3 disposed on a lower side of the plurality of elastic modules 1 and configured to be connected to a plurality of pre-compressed springs 10. Each of the plurality of elastic modules 1 comprises the plurality of pre-compressed springs 10. Middle parts (i.e., waist parts) of the plurality of pre-compressed springs 10 comprise connecting members 11 (e.g., a middle part of each of the plurality of pre-compressed springs 10 is disposed with a connecting member 11). The elastic mattress further comprises one or more lap joints 12, and corresponding ones of the middle parts on adjacent pre-compressed springs 10 of the plurality of pre-compressed springs 10 are connected together. The connecting members 11 are connected to the one or more lap joints 12, and the one or more lap joints 12 are connected to the adjacent pre-compressed springs 10.

More specifically, in this embodiment, each of the connecting members 11 is divided into two connecting member assemblies 111, 112 detachably connected to each other, and the two connecting member assemblies 111, 112 are buckled to each other to form a ring shape, so as to be buckled to a middle part of a corresponding one of the plurality of pre-compressed springs 10. Each of the connecting members 11 comprises a connecting seat 113, and four sides of the connecting seat 113 evenly comprise T-shaped protrusions 114 as insertion members. A first T-shaped protrusion 114 of the T-shaped protrusions 114 on a first pre-compressed springs 10 of the plurality of pre-compressed springs 10 and a second T-shaped protrusion 114 of the T-shaped protrusions 114 on a second pre-compressed springs 10 of the plurality of pre-compressed springs 10 are connected by a corresponding one of the one or more lap joints 12 to realize a connection of the adjacent pre-compressed springs 10.

Each of the one or more lap joints 12 in this embodiment comprises a fixed seat 121 and knobs 122 connected to four sides of the fixed seat 121, and all of four of the knobs 122 comprise grooves 123 configured to be positioned at and cooperate with the T-shaped protrusions 114 as insertion sockets. The knobs 122 are configured to rotate around the grooves 123. The T-shaped protrusions 114 of the connecting members 11 of the plurality of pre-compressed springs 10 are buckled to the grooves 123 of the knobs 122 of the one or more lap joints 12. The T-shaped protrusions 114 can be positioned at and cooperate with the grooves 123 in a horizontal direction, the knobs 122 rotate until the T-shaped protrusions 114 are positioned at and cooperate with the knobs 122 in a vertical direction, and the T-shaped protrusions 114 are locked by the knobs 122 to realize the connection of the adjacent pre-compressed springs 10.

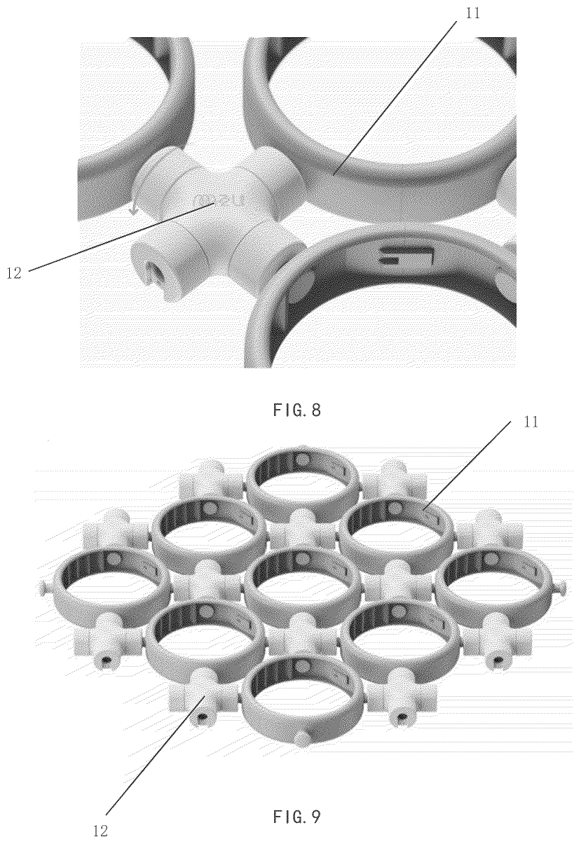

When the plurality of pre-compressed springs 10 are connected together, the T-shaped protrusions 114 are buckled to the grooves 123 of the one or more lap joints 12. At this time, as shown in FIG. 7, the T-shaped protrusions 114 are positioned at and cooperate with the grooves 123 in the horizontal direction. As shown in FIG. 8, the knobs 122 rotate until the knobs 122 are positioned at and cooperate with the T-shaped protrusions 114 in the vertical direction, and the T-shaped protrusions 114 are locked by rotating the knobs 122 to realize the connection of the adjacent pre-compressed springs 10. When the plurality of pre-compressed springs 10 are disassembled, the knobs 122 rotate to release a positioning cooperation with the T-shaped protrusions 114 in the vertical direction, and the T-shaped protrusions 114 are removed to release the connection of the adjacent pre-compressed springs 10.

In this embodiment, each of the one or more lap joints 12 comprises the four of the knobs 122, and each of the one or more lap joints 12 can be connected to four corresponding ones of the connecting members 11 on four of the plurality of pre-compressed springs 10 (e.g., the connecting members 11 are a plurality of connecting members respectively buckled to the plurality of pre-compressed springs 10 in a one-to-one correspondence). The others of the T-shaped protrusions 114 of the connecting members 11 on the four of the plurality of pre-compressed springs are connected to other ones of the one or more lap joints 12, and so on, and the plurality of pre-compressed springs 10 are connected together to form a corresponding one of the plurality of elastic modules 1.

In this embodiment, one or more outermost pre-compressed springs 10 of the plurality of pre-compressed springs 10 on a first one of the plurality of elastic modules 1 and one or more outermost pre-compressed springs 10 of the plurality of pre-compressed springs 10 on a second one of the plurality of elastic modules 1 can be connected using the one or more lap joints 12. As a simple alternative to this embodiment, one or more outermost pre-compressed springs 10 of the plurality of pre-compressed springs 10 on the first one of the plurality of elastic modules 1 and one or more outermost pre-compressed springs 10 of the plurality of pre-compressed springs 10 on the second one of the plurality of elastic modules 1 can also be buckled to each other by the connecting members 11.

In order to judge a usage state and cleanliness of the elastic mattress during use and to clean the elastic mattress or replace parts of the elastic mattress in time according to the usage state, in this embodiment, the one or more upper mattress layers 2 are disposed on an upper side of the plurality of elastic modules 1 and the plurality of pre-compressed springs 10 are exposed to an external side, thereby enabling the elastic mattress to be an open structure. This allows the user to judge the cleanliness of the elastic mattress and wear level of the plurality of pre-compressed springs 10 in time through naked eyes during use.

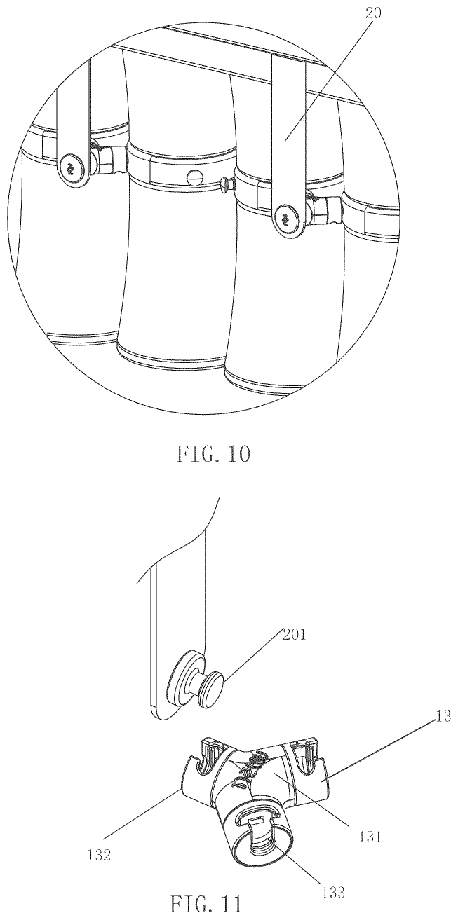

In order to facilitate the user cleaning the elastic mattress and replacing the parts of the elastic mattress, as shown in FIGS. 10-13, in this embodiment, strips 20 having pull buckles are disposed on a periphery of the one or more upper mattress layers 2, and the strips 20 having pull buckles are buckled to corresponding lap joints 12 of the one or more lap joints 12 connected to the one or more outermost pre-compressed springs 10 of the elastic mattress to achieve a detachable connection of the one or more upper mattress layers 2 and the plurality of elastic modules 1.

In this embodiment, the one or more outermost pre-compressed springs 10 of the elastic mattress do not need to be connected to another one of the plurality pf elastic modules 1, and adjacent ones of the one or more outermost pre-compressed springs 10 of the elastic mattress and a corresponding one of the strips 20 having pull buckles of the one or more upper mattress layers 2 are connected together by a three-way lap joint 13. The three-way lap joint 13 comprises a fixed seat 131 and three knobs 132 identical to the knobs 122, and the three knobs 132 comprise three grooves 133. Corresponding ones of the T-shaped protrusions 114 on the adjacent ones of the one or more outermost pre-compressed springs 10 of the elastic mattress and a T-shaped protrusion 201 of the corresponding one of the strips 20 having pull buckles are respectively buckled to the three grooves 133 of the three-way lap joint 13. The knobs 132 rotate to lock the T-shaped protrusion 201 and the corresponding ones of the T-shaped protrusions 114 to realize a fixed connection of the one or more outermost pre-compressed springs 10 of the elastic mattress and to secure the one or more upper mattress layers 2 with the plurality of elastic modules 1. As a simple alternative to this embodiment, the strips 20 having pull buckles can also comprise grooves for a direct connection with the T-shaped protrusions 114 of the connecting members 11.

In this embodiment, according to different needs of the user for softness of the elastic mattress, the one or more upper mattress layers 2 comprise a plurality of mattress layers with different softness or hardness. The user can combine mattress layers having appropriate hardness to form one or more suitable upper mattress layers 2 according to actual needs and preferences for softness of the one or more upper mattress layers 2. A surface of the one or more upper mattress layers 2 can also use leather, ultrafine fiber, cotton, wool, or other materials. As a simple alternative of this embodiment, the one or more upper mattress layers 2 can also be an integrated structure.

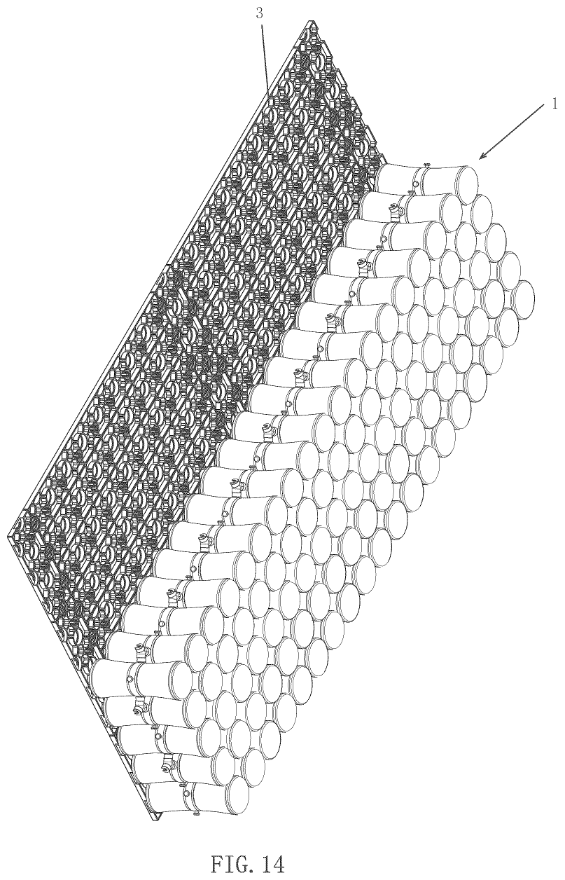

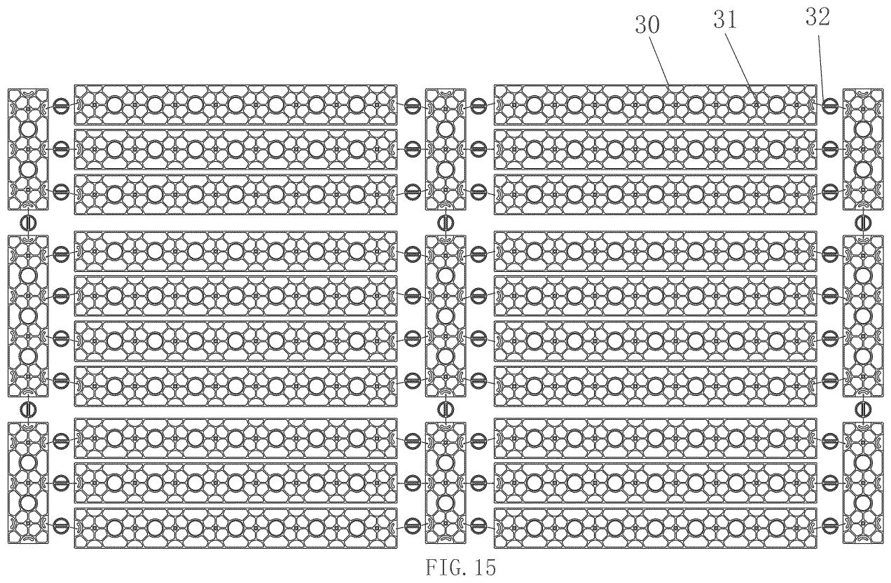

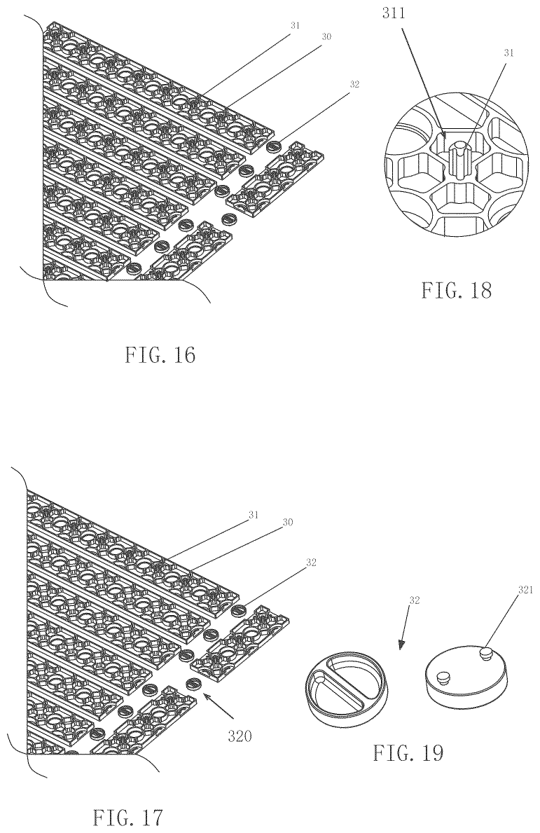

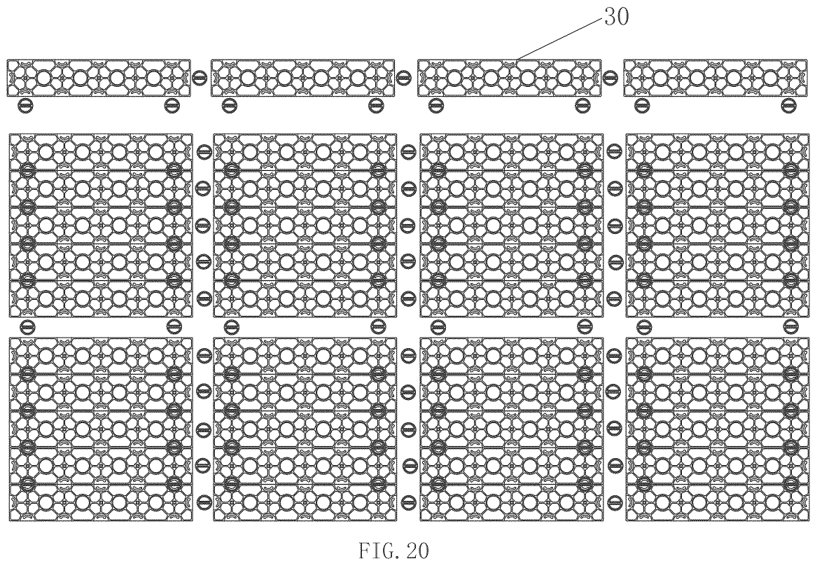

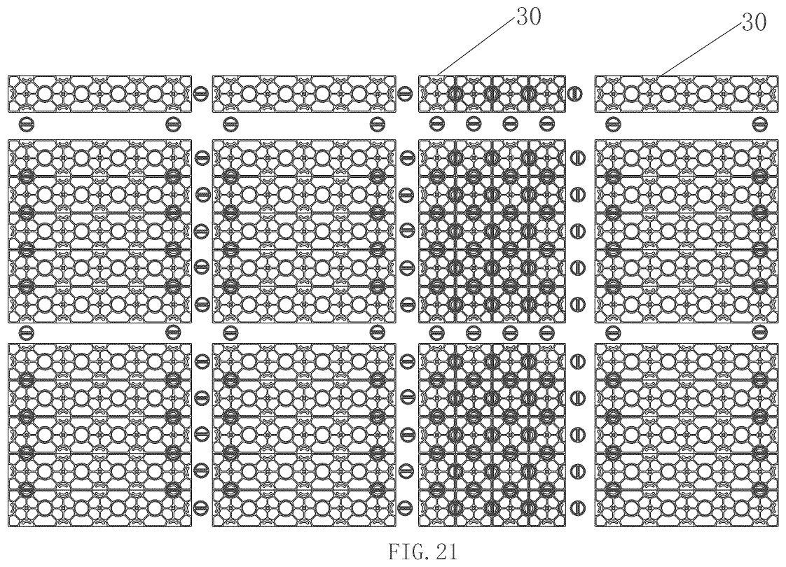

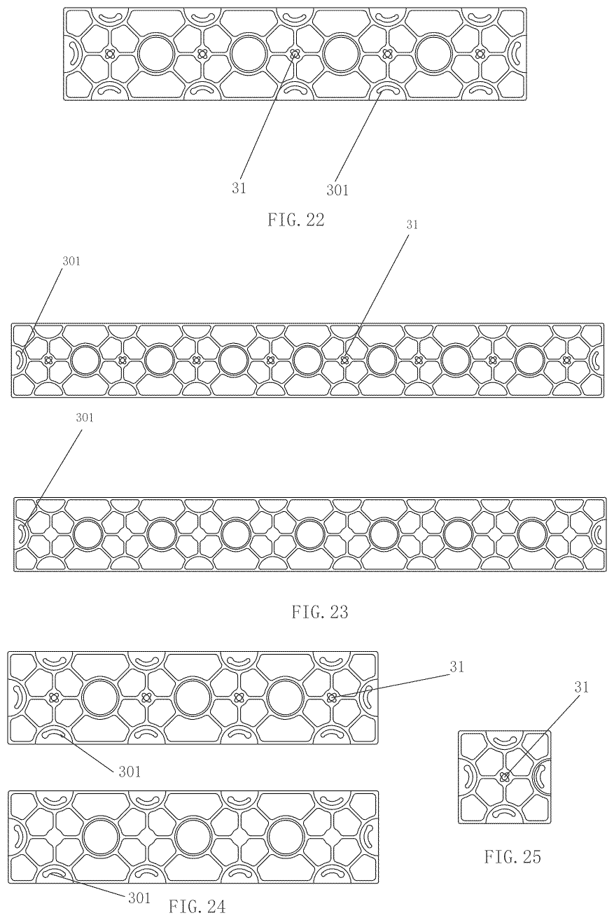

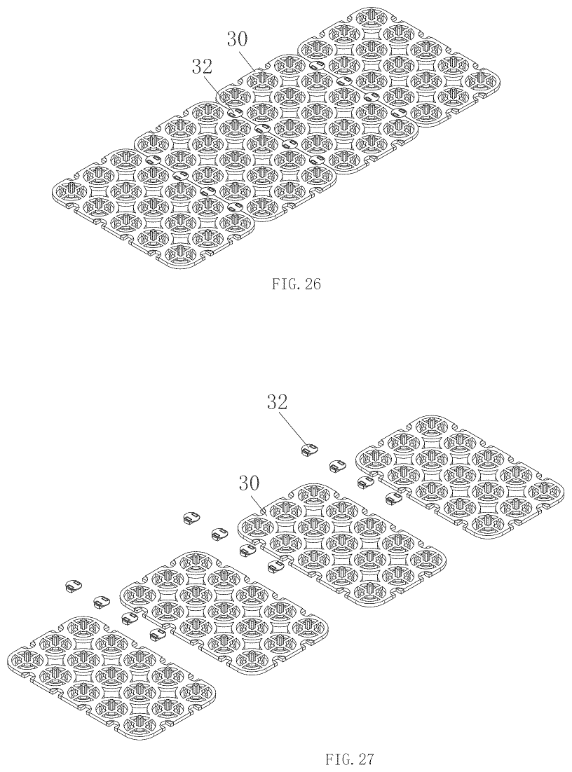

Referring to FIGS. 14-27, in this embodiment, the one or more bottom layers 3 are spliced by a plurality of bottom layer units 30. In order to enable the plurality of pre-compressed springs 10 to be connected to the one or more bottom layers 3, the one or more bottom layers 3 comprise a plurality of positioning protrusions 31 as fixing members 311, and lower end surfaces of the plurality of pre-compressed springs 10 comprise a plurality of cavities 1022 positioned at and cooperating with the plurality of positioning protrusions 31. Therefore, the plurality of pre-compressed springs 10 are connected to the one or more bottom layers 3 using a male-female connection of the plurality of positioning protrusions 31 and the plurality of cavities 1022.

Corresponding ones of the one or more bottom layers 3 form a size as each of the plurality of elastic modules 1 by splicing the plurality of bottom layer units 30 together through connecting knobs 32 (i.e., third members 320). Each of the connecting knobs 32 is a circular knob, and a bottom of each of the circular knobs 32 comprises two T-shaped buckling pins 321 symmetrical to each other. Edges of the plurality of bottom layer units 30 comprise sliding rails 301 configured to be positioned at and cooperate with the two T-shaped buckling pins 321 of each of the connecting knobs 32. Widths of the sliding rails 301 narrow along a rotation direction of the connecting knobs 32, allowing the two T-shaped buckling pins 321 of each of the connecting knobs 32 to be respectively buckled to wide parts of corresponding sliding rails 301 of two adjacent bottom layer units 30 of the plurality of bottom layer units 30. A handle on each of the connecting knobs 32 rotates to enable each of the connecting knobs 32 to rotate until the two T-shaped buckling pins 321 are positioned at narrow parts of the corresponding sliding rails 301, and a connection of the two adjacent bottom layer units 30 is achieved.

As a simple alternative of this embodiment, the corresponding ones of the one or more bottom layers 3 can also be an integrated structure to match the size of each of the plurality of elastic modules 1. At the same time, the plurality of pre-compressed springs 10 are connected together in each of the plurality of elastic modules 1, so that the plurality of positioning protrusions 31 can be located only on some of the bottom layer units 30 on a periphery of the one or more bottom layers 3.

In this embodiment, the elastic mattress is spliced by the plurality of elastic modules 1, and a plurality of bottom layers 3 of the one or more bottom layers 3 connected to the plurality of elastic modules 1 are detachably connected to form a base of the elastic mattress using the connecting knobs 32. Therefore, a specific number of the plurality of elastic modules 1 and the bottom layers 3 that are detachably connected together are spliced together to form the elastic mattress according to actual size requirements of the user.

A size of each of the plurality of bottom layer units 30 can be set arbitrarily, and one of the plurality of bottom layer units 30 can be connected to one or more of the plurality of pre-compressed springs 10. The plurality of bottom layers 3 can be formed by splicing the plurality of bottom layer units 30 with different sizes together through the connecting knobs 32, or by splicing the plurality of bottom layer units 30 with same sizes together through the connecting knobs 32. As a simple alternative of this embodiment, the plurality of bottom layer units 30 and the plurality of bottom layers 3 can also be detachably connected to each other using a plug-in connection, a hinge, etc.

Specifically, the plurality of bottom layers 3 can be formed by splicing a plurality of 8-seat bottom layer units 30 and/or a plurality of 4-seat bottom layer units 30 of the plurality of bottom layer units 30 together, or by splicing a plurality of 5-seat bottom layer units 30 of the plurality of bottom layer units 30 together, or by splicing a plurality of 1-seat bottom layer units 30 and/or a plurality of 5-seat bottom layer units 30 of the plurality of bottom layer units 30 together. A seat number of the plurality of bottom layer units 30 and a combination for splicing are not limited to the description mentioned in this embodiment.

In this embodiment, the plurality of bottom layers 3 connected to the plurality of pre-compressed springs 10 are formed by a rigid substrate, and the rigid substrate can be a rigid material, such as a wood board, a vacuum-formed plastic board, etc. As a simple alternative of this embodiment, the plurality of bottom layers 3 can also be formed by a flexible substrate.

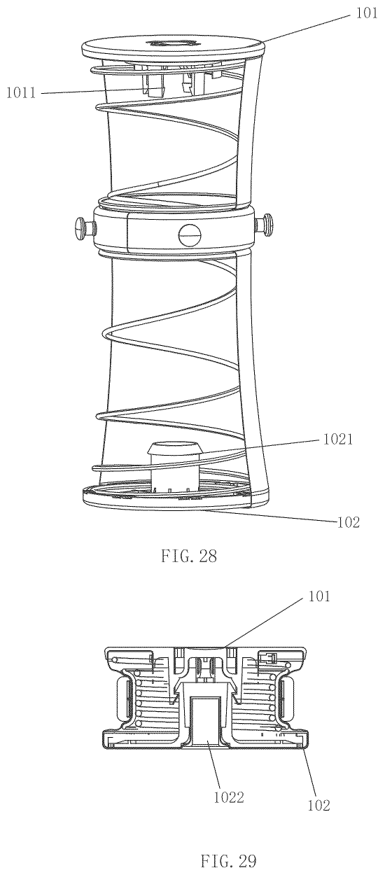

Referring to FIGS. 28-29, in this embodiment, in order to facilitate transportation or relocation of the elastic mattress after disassembly, the plurality of pre-compressed springs 10 can be compressed to a locked state. A height of the plurality of pre-compressed springs 10 compressed to the locked state is greatly reduced, and occupied space is reduced to facilitate the transportation and the relocation. More specifically, each of the plurality of pre-compressed springs 10 comprises a top cover 101 and a bottom cover 102. The top cover 101 comprises a first positioning structure 1011, the bottom cover 102 comprises a second positioning structure 1021, and the first positioning structure 1011 is detachably buckled to the second positioning structure 1021. A lower end surface of the bottom cover 102 of each of the plurality of pre-compressed springs 10 comprises a corresponding one of the plurality of cavities 1022 positioned at and cooperating with a corresponding one of the plurality of positioning protrusions 31. The bottom cover 102 defines a top surface of the corresponding one of the plurality of cavities 1022, and the second positioning structure 1021 is discontinuous flanges disposed on an outer periphery of an upper end of the corresponding one of the plurality of cavities 1022. Each of the plurality of pre-compressed springs 10 is compressed using an external force to enable hooks of the first positioning structure 1011 and the discontinuous flanges of the second positioning structure 1021 to be buckled together, thereby achieving a compression (i.e., a locked state) of the plurality of pre-compressed springs 10. The external force can then be used to enable each of the plurality of pre-compressed springs 10 to rotate to enable the first positioning structure 1011 to rotate to be separated from the second positioning structure 1021 to achieve releasing of each of the plurality of pre-compressed springs 10 from the locked state.

The aforementioned description of the specification and the embodiments is used to explain the protection scope of the present disclosure instead of a limitation of the protection scope of the present disclosure. Modifications, equivalent substitutions, or other improvements of the embodiments or some technical features thereof of the present disclosure fall within the protection scope of the present disclosure provided that they are obtained by a person of ordinary technical skill in the art through logical analysis, reasoning, or limited experiments by combining common knowledge and ordinary technical knowledge in the art and/or the existing techniques through the hint of the present disclosure or the aforementioned embodiments.

What is claimed is:

1. An elastic mattress, comprising:
one or more elastic modules,
one or more bottom layers disposed on a lower side of the one or more elastic modules, and
one or more lap joints, wherein:
the one or more elastic modules comprises a plurality of pre-compressed springs,
connecting members are disposed on middle parts of the plurality of pre-compressed springs,
corresponding ones of the middle parts on adjacent pre-compressed springs of the plurality of pre-compressed springs are connected together,
the connecting members are connected to the one or more lap joints,
the one or more lap joints are connected to the adjacent pre-compressed springs, and
bottom surfaces of the plurality of pre-compressed springs are connected to the one or more bottom layers.

2. The elastic mattress according to claim 1, wherein:
the connecting members comprise connecting seats,
the connecting seats comprise first connecting structures,
the one or more lap joints comprise one or more second connecting structures, and
the first connecting structures are connected to the one or more second connecting structures to realize a connection of the connecting members and the one or more lap joints.

3. The elastic mattress according to claim 2, wherein:
the connecting seats comprise insertion members as the first connecting structures,
the one or more lap joints comprises one or more insertion sockets as the one or more second connecting structures, and
a male-female connection of the insertion members and the one or more insertion sockets realizes the connection of the connecting members and the one or more lap joints.

4. The elastic mattress according to claim 3, wherein:
the connecting seats comprise protrusions as the insertion members,
the one or more lap joints comprises grooves as the one or more insertion sockets, and
the protrusions are positioned at and cooperate with the grooves.

5. The elastic mattress according to claim 4, wherein:
the protrusions are evenly disposed on four sides of the connecting seats.

6. The elastic mattress according to claim 4, wherein:
the grooves are disposed on four sides of the one or more lap joints.

7. The elastic mattress according to claim 6, wherein:
the one or more lap joints comprise one or more fixed seats and knobs connected to four sides of the one or more fixed seats,
the knobs comprises the grooves configured to be matched with the protrusions, and
the protrusions are locked by rotating the knobs, after the protrusions are buckled to the grooves, so as to realize the connection of the connecting members and the one or more lap joints.

8. The elastic mattress according to claim 1, wherein:
one or more pre-compressed springs of the plurality of pre-compressed springs at an outer periphery of the one or more elastic modules are connected by corresponding ones of the one or more lap joints or buckled to each other by corresponding ones of the connecting members.

9. The elastic mattress according to claim 1, wherein:
each of the connecting members comprises two or more connecting member assemblies buckled to a corresponding one of the middle parts of the plurality of pre-compressed springs.

10. The elastic mattress according to claim 9, wherein:
the two or more connecting member assemblies of each of the connecting members are buckled to each other.

11. The elastic mattress according to claim 1, further comprising:
one or more upper mattress layers, wherein:
the one or more upper mattress layers are disposed on an upper side of the one or more elastic modules or cover an upper side and a periphery of the one or more elastic modules.

12. The elastic mattress according to claim 11, wherein:
the one or more upper mattress layers are detachably connected to one or more outermost pre-compressed springs of the plurality of pre-compressed springs of the one or more elastic modules.

13. The elastic mattress according to claim 12, wherein:
a plurality of strips having pull buckles are disposed on a periphery of the one or more upper mattress layers,
the plurality of strips having pull buckles are connected to corresponding ones of the connecting members or corresponding ones of the one or more lap joints, and
the corresponding ones of the connecting members or the corresponding ones of the one or more lap joints are located on one or more peripheral pre-compressed springs of the plurality of pre-compressed springs of the one or more elastic modules.

14. The elastic mattress according to claim 11, wherein:
the one or more upper mattress layers are integrally formed or formed by combining a plurality of mattress layers of the one or more upper mattress layers with different softness and hardness.

15. The elastic mattress according to claim 1, wherein:
the one or more bottom layers are detachably spliced by a plurality of bottom layer units or integrally molded.

16. The elastic mattress according to claim 15, wherein:
the one or more bottom layers comprise a plurality of bottom layers, and
the plurality of bottom layers are detachably spliced together to form a base for the one or more elastic modules.

17. The elastic mattress according to claim 16, wherein:
the plurality of bottom layer units or the plurality of bottom layers are connected together through third members.

18. The elastic mattress according to claim 17, wherein:
the third members are connecting knobs,
a bottom of each of the connecting knobs comprises two T-shaped buckling pins symmetrical to each other,
a periphery of each of the plurality of bottom layer units or a periphery of each of the plurality of bottom layers comprises sliding rails,
each of the sliding rails is configured to be connected to a corresponding one of the two T-shaped buckling pins of a corresponding one of the connecting knobs,
widths of the sliding rails narrow along a rotation direction of the connecting knobs,
the two T-shaped buckling pins of each of the connecting knobs are respectively buckled to a wide part of a corresponding one of the sliding rails on a first bottom layer unit of the plurality of bottom layer units or a first bottom layer of the plurality of bottom layers and a wide part of a corresponding one of the sliding rails on a second bottom layer unit of the plurality of bottom layer units adjacent to the first bottom layer unit or a second bottom layer of the plurality of bottom layers adjacent to the first bottom layer, and
each of the connecting knobs rotates to enable the two T-shaped buckling pins to be positioned to a narrow part of the corresponding one of the sliding rails on the first bottom layer unit or the first bottom layer and a narrow part of the corresponding one of the sliding rails on the second bottom layer unit or the second bottom layer, so as to achieve a connection between the first bottom layer unit and the second bottom layer unit or a connection between the first bottom layer and the second bottom layer.

19. The elastic mattress according to claim 15, wherein:
the plurality of pre-compressed springs are connected to the one or more bottom layers through fixing members,
at least part of the one or more bottom layers is disposed with the fixing members,
the fixing members are a plurality of positioning protrusions disposed on the plurality of bottom layer units,
lower end surfaces of the plurality of pre-compressed springs comprise a plurality of cavities configured to be positioned at and cooperate with the plurality of positioning protrusions, and
the plurality of pre-compressed springs are connected to the one or more bottom layers by a male-female connection between the plurality of positioning protrusions and the plurality of cavities.

20. The elastic mattress according to claim 1, wherein:
each of the plurality of pre-compressed springs comprises a top cover and a bottom cover,
a spring is disposed between the top cover and the bottom cover,
positioning structures are disposed between the top cover and the bottom cover, and
the top cover is buckled to the bottom cover through the positioning structures to compress each of the plurality of pre-compressed springs to a locked state.

21. The elastic mattress according to claim 20, wherein:
the positioning structures are divided into a first positioning structure and a second positioning structure,
the first positioning structure is disposed on a lower end surface of the top cover,
the second positioning structure is disposed on an upper end surface of the bottom cover,
the first positioning structure and the second positioning structure are detachably buckled to each other,
when the first positioning structure and the second positioning structure are buckled to each other, each of the plurality of pre-compressed springs is compressed, and
when the first positioning structure and the second positioning structure are detached from each other, each of the plurality of pre-compressed springs is released.

22. A method for applying the elastic mattress, comprising: applying the elastic mattress according to claim 1 in a sofa, a bed mattress, or a soft stool.
